(19) United States
(12) Patent Application Publication
(10) Pub. No.: US 2022/0051390 A1
(43) Pub. Date: Feb. 17, 2022

(54) DEFECT INSPECTION APPARATUS AND DEFECT INSPECTION METHOD

(71) Applicant: Shimadzu Corporation, Kyoto (JP)

(72) Inventors: Koki YOSHIDA, Kyoto-shi (JP); Takahide HATAHORI, Kyoto-shi (JP); Kenji TAKUBO, Kyoto-shi (JP)

(21) Appl. No.: 17/296,934

(22) PCT Filed: Nov. 27, 2018
(86) PCT No.: PCT/JP2018/043562

§ 371 Date: May 25, 2021

(51) Int. Cl. G06T 7/00; H04N 9/70; G06T 7/90; H04N 9/64; G06T 7/521; G01N 29/24; G01N 29/06

(52) U.S. Cl. CPC G06T 7/0004; H04N 9/70; G06T 7/90; H04N 9/643; G06T 7/521; G01N 2291/0289; G01N 29/0609; G01N 29/069; G06T 2207/10152; G06T 2207/30164; G01N 29/2418

(57) ABSTRACT

This defect inspection apparatus (100) is provided with: an excitation unit (1), a laser illumination unit (2), an interference unit (3) for causing laser light to interfere; an imaging unit (35) for imaging the interfered reflected light; and a control unit (4). The control unit (4) is configured to measure a spatial distribution of periodically varying physical properties caused by propagation of vibration of an inspection target, based on the interfered reflected light imaged by an imaging unit and extract a vibration discontinuous portion based on the spatial distribution of the physical quantities. The control unit is configured to perform control of displaying the extracted vibration discontinuous portion so as to be emphasized and superimposed on a still image of the inspection target captured by the imaging unit.

### TECHNICAL FIELD

The present invention relates to a defect inspection apparatus and a defect inspection method.

### BACKGROUND ART

Conventionally, a defect inspection apparatus is known. A defect inspection apparatus is disclosed in, for example, WO 2017/221324.

WO 2017/221324 discloses an acoustic wave propagating imaging apparatus (defect inspection apparatus). The acoustic wave propagation imaging apparatus is provided with an acoustic wave imparting unit, a pulsed laser light source, a speckle shearing interferometer, an image sensor, and a control and processing unit. The acoustic wave imparting unit is configured to impart an acoustic wave (including any elastic waves propagating through gas, liquid, or solid) on the surface of the measurement target. The pulsed laser light source is configured to irradiate the measurement target with pulsed laser light. The speckle shearing interferometer is configured to cause the reflected light of the pulsed laser light arriving from mutually different positions of the measurement target to which an acoustic wave vibration (hereinafter simply referred to as “vibration”) is being imparted by the acoustic wave imparting unit. The image sensor is configured to image the interfered reflected light. The control and processing unit is configured to generate a moving image related to the propagation of vibration of the measurement target, based on the interfered reflected light imaged by the image sensor. The defect of the measurement target is acquired based on the moving image related to the propagation of vibration generated by this acoustic propagation imaging apparatus.

### PRIOR ART DOCUMENT

### Patent Document

Patent Document 1: WO2017/221324

### SUMMARY OF THE INVENTION

### Problems to be Solved by the Invention

In the acoustic propagation imaging apparatus (defect inspection apparatus) disclosed in WO 2017/221324, it is described that a vibration propagation discontinuous portion is detected as a defect. However, the vibration propagation discontinuity occurs also at a portion having a discontinuous shape and structure in an object with no defect. Therefore, in order to determine whether or not vibration propagation discontinuity is actually caused by a defect, it is required to compare the information on the propagation of vibration with the information on the shape and structure of the target.

The present invention has been made to solve the above problems. One object of the present invention is to provide a defect inspection apparatus and a defect inspection method capable of easily grasp a position where propagation of vibration with respect to an inspection target is discontinuous and also capable of easily distinguishing between the shape and structure of the inspection target and a defect.

### Means for Solving the Problem

In order to attain the above-described objects, the defect inspection apparatus according to a first aspect of the present invention includes:
an excitation unit configured to excite acoustic wave vibration in an inspection target;
a laser illumination unit configured to irradiate the inspection target with laser light;
an interference unit configured to cause reflected light of the laser light arriving from mutually different positions of the inspection target excited by the excitation unit to interfere;
an imaging unit configured to image the interfered reflected light; and
a control unit configured to measure, based on the interfered reflected light imaged by the imaging unit, a periodically varying spatial distribution of physical quantities caused by propagation of vibration of the inspection target and extract, based on the spatial distribution of the physical quantities, a vibration discontinuous portion,
wherein the control unit is configured to perform control of displaying the extracted vibration discontinuous portion so as to be emphasized and superimposed on a still image of the inspection target captured by the imaging unit

In the defect inspection apparatus according to the first aspect of the present invention, as described above, it is provided with a controller for performing control of displaying the extracted vibration discontinuous portion so as to be emphasized and superimposed on a still image of an inspection target captured by an imaging unit. With this, it is possible to confirm the vibration discontinuous portion extracted from the spatial distribution of the physical quantities while confirming the shape and structure of the inspection target by the still image. This makes it easy to see and compare the still image of the inspection target with the emphasized display of the vibration discontinuous portion, so that the position where the propagation of vibration with respect to the inspection target is discontinuous can be easily identified. Further, the shape of the inspection target can be confirmed by the still image of the inspection target. Consequently, the position where the propagation of vibration with respect to the inspection target is discontinuous can be easily grasped, and the shape and structure of the inspection target can be easily distinguished from a defect.

In order to attain the above-described object, the defect inspection method according to a second aspect of the present invention includes:
exciting acoustic wave vibration in an inspection target;
irradiating an inspection target with laser light;
causing reflected light of the laser light arriving from mutually different positions of the excited inspection target to interfere;
imaging the interfered reflected light;
measuring spatial distribution of periodically varying physical quantities caused by propagation of vibration of the inspection target, based on the imaged interfered reflected light;
extracting a vibration discontinuous portion based on the spatial distribution of the physical quantities; and
displaying the extracted vibration discontinuous portion so as to be emphasized and superimposed on the captured still image of the inspection target.

In the defect inspection method according to the second aspect of the present invention, as described above, the extracted vibration discontinuous portion is emphasized and displayed on the still image of the imaged inspection target. This makes it possible to confirm the vibration discontinuous portion extracted from the spatial distribution of physical quantities while confirming the shape and structure of the inspection target by the still image. With this, it is possible to compare the still image of the inspection target with the emphasized display of the vibration discontinuous portion, so that the position where the propagation of vibration with respect to the inspection target is discontinuous can be easily identified. In addition, the shape of the inspection target can be confirmed by the still image of the inspection target. Consequently, it is possible to provide a defect inspection method capable of easily identifying the position where the propagation of vibration with respect to the inspection target is discontinuous and also capable of easily distinguishing from the shape and structure of the inspection target with a defect.

### Effects of the Invention

As described above, according to the present invention, it is possible to easily grasp the position where the propagation of vibration with respect to the inspection target is discontinuous. It is also possible to easily distinguish the shape and structure of the inspection target from a defect.

### BRIEF DESCRIPTION OF THE DRAWINGS

FIG. 1 is a block diagram showing the configuration of a defect inspection apparatus according to an embodiment of the present invention.

FIG. 2 is a diagram for explaining the displaying of a defect of the defect inspection apparatus by one embodiment of the present invention.

FIG. 3 shows an example of the display of the defect inspection apparatus according to an embodiment of the present invention.

FIG. 4 is a flowchart for explaining defect display processing by the controller of the defect inspection apparatus according to an embodiment of the present invention.

FIG. 5 is a block diagram showing the configuration of the defect inspection apparatus according to a modification of an embodiment of the present invention.

### EMBODIMENTS FOR CARRYING OUT THE INVENTION

Hereinafter, an embodiment in which the present invention is embodied will be described with reference to the attached figures.

### (Configuration of Defect Inspection Apparatus)

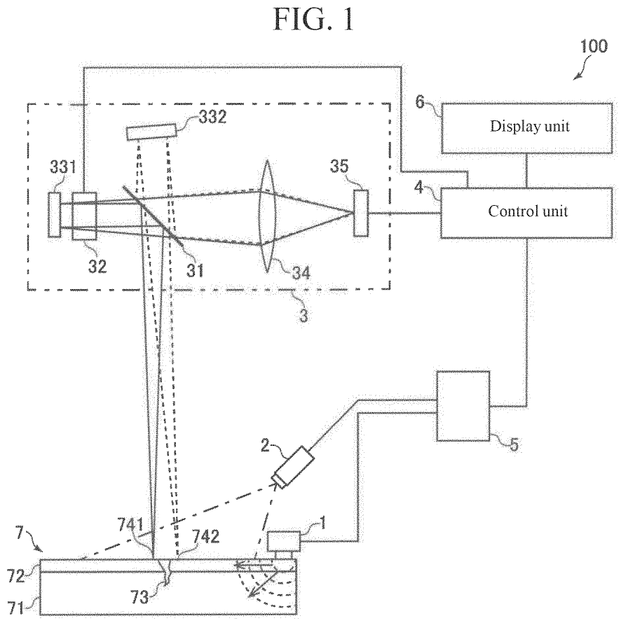

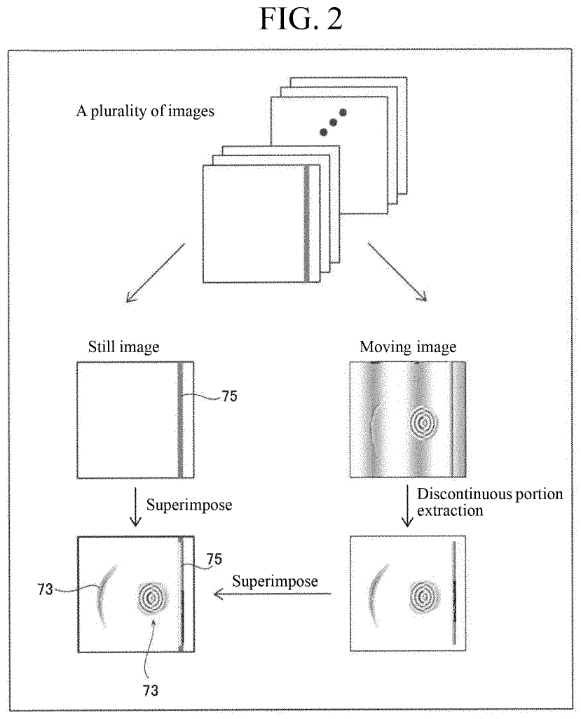

Referring to FIG. 1 and FIG. 2, the configuration of a defect inspection apparatus 100 according to an embodiment of the present invention will be described. The defect inspection apparatus 100 is a device for inspecting a defect of an inspection target 7.

The defect inspection apparatus 100 according to this embodiment includes a vibrator 1, a laser illumination unit 2, a speckle shearing interferometer 3, a control unit 4, a signal generator 5, and a display unit 6. Note that the vibrator 1 is one example of the “excitation unit” recited in claims, and the speckle shearing interferometer 3 is one example of the “interference unit” recited in claims.

The vibrator 1 and the laser illumination unit 2 are connected to the signal generator 5 via a cable.

The vibrator 1 excites vibration (acoustic wave vibration) in the inspection target 7. Specifically, the vibrator 1 is arranged so as to contact the inspection target 7. The vibrator 1 converts an alternating electrical signal from the signal generator 5 into mechanical vibration and imparts vibration (acoustic wave vibration) in the inspection target 7.

The laser illumination unit 2 emits laser light to the inspection target 7. The laser illumination unit 2 includes a laser light source and an illumination light lens (not shown). The illumination light lens emits laser light emitted from the laser light source so as to be expanded to illuminate to the entire measurement region on the surface of the inspection target 7. The laser illumination unit 2 emits laser light at a predetermined timing based on the electric signal from the signal generator 5. That is, the laser illumination unit 2 irradiates the inspection target 7 with the laser light corresponding to the vibration by the vibrator 1.

The speckle shearing interferometer 3 is configured to cause interference of reflected light of the laser light arriving from mutually different positions of the inspection target 7 excited by the vibrator 1. The speckle shearing interferometer 3 includes a beam splitter 31, a phase shifter 32, a first reflecting mirror 331, a second reflecting mirror 332, a condenser lens 34, and an image sensor 35. Note that the image sensor 35 is one example of the “imaging unit” recited in claims.

The beam splitter 31 includes a half mirror. The beam splitter 31 is arranged at a position where the laser light reflected by the front surface of the inspection target 7 is incident. Further, the beam splitter 31 reflects the incident laser light toward the phase shifter 32 and transmits the laser light to the second reflecting mirror 332 side. Further, the beam splitter 31 reflects the laser light incident by being reflected by the second reflecting mirror 332 to the condenser lens 34 side and transmits the laser light incident by being reflected by the first reflecting mirror 331 to the condenser lens 34 side.

The first reflecting mirror 331 is arranged at an angle of 45 degrees with respect to the reflection surface of the beam splitter 31 on the optical path of the laser light reflected by the beam splitter 31. The first reflecting mirror 331 reflects the laser light beam incident by being reflected by the beam splitter 31 to the beam splitter 31 side.

The second reflecting mirror 332 is arranged at an angle slightly inclined from an angle of 45 degrees with respect to the reflection surface of the beam splitter 31 on the optical path of the laser light transmitted through the beam splitter 31. The second reflecting mirror 332 reflects the laser light incident by being reflected by the beam splitter 31 to the beam splitter 31 side.

The phase shifter 32 is arranged between the beam splitter 31 and the first reflecting mirror 331 to change (shift) the phase of the transmitted laser light by the control of the control unit 4. Specifically, the phase shifter 32 is configured to change the optical path length of the laser light that passes therethrough.

The image sensor 35 has a large number of detecting elements and is arranged on the optical path of the laser light (see the solid line in FIG. 1) reflected by the first reflecting mirror 331 after being reflected by the beam splitter 31 and transmitted the beam splitter 31 and the laser light (see the broken line in FIG. 1) reflected by the beam splitter 31 after being transmitted the beam splitter 31 and reflected by the second reflecting mirror 332. The image sensor 35 includes, for example, a CMOS image sensor or a CCD image sensor. The image sensor 35 is configured to image the incident laser light. Further, the image sensor 35 is configured to image the reflected light interfered by the speckle shearing interferometer 3.

The condenser lens 34 is arranged between the beam splitter 31 and the image sensor 35 to focus the laser light reflected by the beam splitter 31 (see the solid line in FIG. 1) and the laser light transmitted through the beam splitter 31 (dashed line in FIG. 1).

The laser light (see the solid line in FIG. 1) reflected by the position 741 on the surface of the inspection target 7 and the first reflecting mirror 331 and the laser light (see the dashed line in FIG. 1) reflected by the position on the surface of the inspection target 7 and the second reflecting mirror 332 interfere with each other and are incident on the same location of the image sensor 35. The position 741 and the position 742 are spaced apart from each other by a minute distance. Further, in the same manner, the reflected light of the laser light arriving from mutually different positions at the positions of each region of the inspection target 7 is guided by the speckle shearing interferometer 3. Then, it is incident on the image sensor 35.

The control unit 4 operates a phase shifter 32 disposed in the speckle shearing interferometer 3 with an actuator (not shown) to change the phase of the transmitting laser light. With this, the phase difference between the laser light reflected at the position 741 and the laser light reflected at the position 742 changes. Each detecting element of the image sensor 35 detects the intensity of the interference light in which these two laser light interfered.

The control unit 4 controls the timing of the vibration of the vibrator 1 and the irradiation of the laser light of the laser illumination unit 2 via the signal generator 5 and captures the image while changing the phase shift amount. The phase shift amount is changed by λ/4, and a total of 37 pieces of images i.e., 32 pieces of images at the timing j (j=0 to 7) of the laser radiation and 5 pieces of images before and after each shift amount (0, λ/4, λ/2, 3λ/4), are captured, at every phase shift amount (0, λ/4, λ/2, 3λ/4). Note that λ denotes a wavelength of the laser light.

The control unit 4 processes the detection signal from each detecting element in the following procedures to acquire a moving image representing the vibration status. The control unit 4 measures, based on the interfered reflected light captured by the image sensor 35, the spatial distribution of the periodically varying physical quantities due to the propagation of vibration of the inspection target 7. For example, the control unit 4 generates, based on the interfered reflected light captured by the image sensor 35, a moving image relating to the propagation of vibration of the inspection target 7.

The control unit 4 obtains the optical phase (phase difference between two optical paths when the phase shift amount is 0) Φj from the luminance values Iⱼ₀˜Iⱼ₃ of images (four sheets) in which the timing j (j=0 to 7) of the laser irradiation is the same and the phase shift amount of the laser irradiation differs by λ/4, by the following Expression (1).

Φⱼ=−arctan {(Iⱼ₃−Iⱼ₁)/(Iⱼ₂−Iⱼ₀)} (1)

Further, the control unit 4 performs the sine wave approximation on the optical phase Φj by a least-squares method to obtain the approximation coefficients A, θ, and C in Expression (2).

Φⱼ=A cos(θ+jπ/4)+C=B exp(jπ/4)+C (2)

where B is a complex amplitude and is expressed by Expression (3).

B=A exp(iθ):Complex amplitude (3)

Further, the control unit 4 constitutes and outputs moving images (30 to 60 frames) for displaying the optical phase change at each phase time ζ (0≤ζ<2π) of the vibration, from the approximate expression obtained by removing the constant term C from Equation (3). In the above-described procedure, a spatial filter is appropriately applied to the complex amplitude B in order to remove noise. Further, the phase shift amount or the step of the laser irradiation timing (in the above example, λ/4 and T/8, respectively, where T is a period of vibration) is not limited thereto. In this case, the calculation expression is different from the above-described Equations (1) to (3).

The control unit 4 applies a spatial filter and detects a discontinuous region in the vibration status as a defect portion 73 of the inspection target 7 from the above-described moving image. That is, the control unit 4 extracts the vibration discontinuous portion, based on the spatial distribution of the physical quantities. In a case where the shape of the inspection target 7 itself includes irregularities or the like, even at a boundary between a flat portion and an uneven portion, discontinuous of vibration state may occur. The control unit 4 may consider the shape information on the inspection target 7 so as not to detect it as a defect and detect the defect portion 73.

Here, in this embodiment, as shown in FIG. 2, the control unit 4 is configured to perform control of displaying the extracted vibration discontinuous portion so as to be emphasized and superimposed on the still image of the inspection target 7 captured by the image sensor 35. The control unit 4 is configured to acquire one still image based on a plurality of still images captured by the imaging unit. Specifically, the control unit 4 is configured to acquire a single still image by addition averaging a plurality of still images captured to generate a moving image relating to the propagation of vibration of the inspection target 7. In this still image, the change portion 75 in the structure of the inspection target 7 can be identified. Note that although the moving image relating to the propagation of vibration of the inspection target 7 can be confirmed for vibration, it is difficult to visually confirm the structure of the inspection target 7. The control unit 4 is configured to perform control of displaying the extracted vibration discontinuous portion so as to be emphasized and superimposed on a single still image obtained by addition averaging.

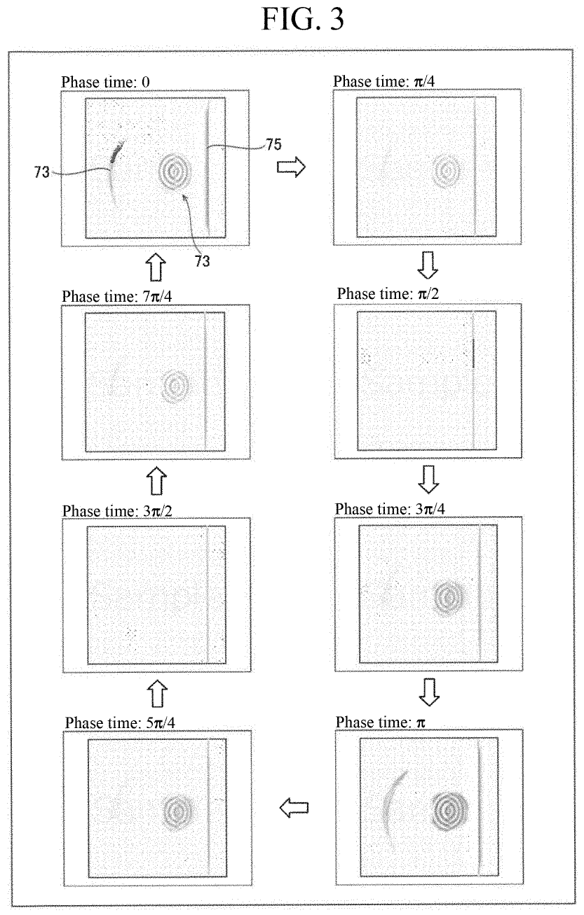

In addition, the control unit 4 is configured to perform control of emphasizing and displaying by changing colors to be superimposed on the still image in accordance with the change in the physical quantities of the extracted vibration discontinuous portion. Specifically, the control unit 4 is configured to perform control of emphasizing and displaying by changing the color to be displayed on the still image in accordance with the change in each phase time of the extracted vibration discontinuous portion. Specifically, the control unit 4 is configured to display the vibration discontinuous portion so as to be superimposed on the still image by changing the color for emphasizing the display, like the display example shown in FIG. 3, in accordance with the change in each phase time of the vibration discontinuous portion. Note that the frame interval of actual moving images to be displayed in a superimposed manner is different from π/4 shown in FIG. 3. Further, the control unit 4 is configured to perform control so that there is a timing that eliminates the color tone when changing the color to be displayed on the still image in accordance with the change in the physical quantities of the extracted vibration discontinuous portion. That is, in the timing of π/2 and 3π/2 in the case of FIG. 3, the color tone of the emphasized portion disappears. In this situation, the still image allows the structure at vibration discontinuous portion of the inspection target 7 to be easily confirmed visually. The extracted vibration discontinuous portion changes periodically. As a result, the emphasize display of the vibration discontinuous portion is displayed so as to blink while changing colors with respect to the still image. For example, in the example show in FIG. 3, 0, π/4, and 7π/4, and π, 5π/4, and 3π/4 are displayed by inverting the color tone of the emphasized display, respectively. Note that in the example of FIG. 3, an example is shown in which the phase of the display of the plurality of discontinuous portions of vibration shows the same example, but the phase that varies depending on the portion may be different.

The display unit 6 displays a moving image representing the vibration status of the inspection target 7 generated in the control unit 4 and an image in which the extracted vibration discontinuous portion is emphasized and superimposed on the still image. The display unit 6 includes a liquid crystal display or an organic EL (electroluminescence) display.

The inspection target 7 is a coated steel sheet in which a coating film 72 is coated on the surface of the steel plate 71. The defect portion 73 includes cracks and peelings.

### (Defect Display Processing)

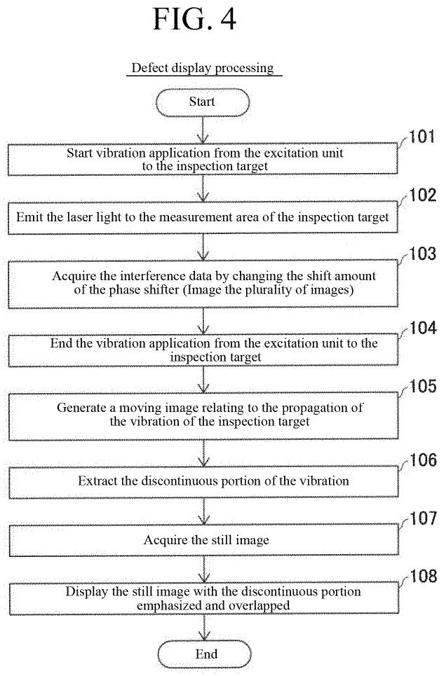

Next, referring to FIG. 4, the defect display processing by the defect inspection apparatus 100 of this embodiment will be described based on a flowchart. Note that the defect display processing is performed by the control unit 4.

In Step 101 of FIG. 4, vibration imparting from the vibrator 1 to the inspection target 7 is started. With this, vibration is excited in the inspection target 7. In Step 102, from the laser illumination unit 2, laser light is emitted to the measurement region of the inspection target 7.

In Step 103, while changing the shift amount of the phase shifter 32, interference data is obtained. In other words, a plurality of images interfered with different phases is imaged. With this, the phase shifter 32 of the speckle shearing interferometer 3 is operated in such a manner that the phase of the laser light is changed by λ/4, and the intensity of the interference light of the laser light at each phase is detected (imaged) by the image sensor 35.

In Step 104, vibration imparting from the vibrator 1 to the inspection target 7 is completed. In Step 105, a moving image relating to the propagation of vibration of the inspection target 7 is generated.

In Step 106, the vibration discontinuous portion is extracted based on the moving image relating to the propagation of vibration of the inspection target 7. In Step 107, one still image is obtained based on the plurality of still images.

In Step 108, the vibration discontinuous portion extracted on the still image is emphasized and displayed. Thereafter, the defect display processing is terminated by inputting a termination instruction or the like from the user (operator).

### Effects of this Embodiment

In this embodiment, the following effects can be obtained.

In this embodiment, as described above, it is provided with the control unit 4 for performing control of displaying the extracted vibration discontinuous portion so as to be emphasized and superimposed on the still image of the inspection target 7 captured by the image sensor 35. With this, it is possible to confirm the vibration discontinuous portion extracted from the spatial distribution of physical quantities while confirming the shape and structure of the inspection target 7 by the still image. With this, since it is possible to compare the still image of the inspection target 7 with the emphasized display of the vibration discontinuous portion, the position where the propagation of vibration with respect to the inspection target 7 is discontinuous can be easily grasped. Further, the shape of the inspection target 7 can be confirmed by the still image of the inspection target 7. Consequently, the position where the propagation of vibration with respect to the inspection target 7 is discontinuous can be easily grasped, and the shape and structure of the inspection target 7 can be distinguished from a defect.

Further, in this embodiment, as described above, the control unit 4 is configured to perform control of displaying the physical quantities that changes periodically in the extracted vibration discontinuous portion as a moving image so as to be superimposed on the still image. As a result, it is possible to easily confirm the state of the change of the physical quantities that changes periodically, by the moving image superimposed on the still image.

Further, in this embodiment, as described above, the control unit 4 is configured to perform control of emphasizing and displaying by changing the color to be displayed on the still image in accordance with the change in the physical quantities of the extracted vibration discontinuous portion. This makes it easy to confirm the vibration discontinuous portion because the color at the vibration discontinuous portion changes according to the change in the physical quantities of the vibration discontinuous portion.

Further, in this embodiment, as described above, the control unit 4 is configured to perform control such that there exists a timing to eliminate the color tone when changing the color to be displayed superimposed on the still image in accordance with the change in the physical quantities of the extracted vibration discontinuous portion. With this, the color tone of the vibration discontinuous portion disappears and therefore it becomes possible to confirm in a state in which the emphasized display is not superimposed on the vibration discontinuous portion in the still image. Therefore, it is possible to more easily visually confirm the vibration discontinuous portion in the still image.

Further, in this embodiment, as described above, the control unit 4 is configured to perform control of displaying the extracted vibration discontinuous portion so as to be emphasized and superimposed on a single still image acquired based on a plurality of still images captured by the image sensor 35. With this, it is possible to perform the imaging of an image for generating a moving image relating to the propagation of vibration of the inspection target 7 and the imaging of still image in common. Therefore, unlike when performing imaging separately, it is possible to suppress the imaging time becomes longer.

### Modified Embodiment

It should be understood that the embodiments disclosed here are examples in all respects and are not restrictive. The scope of the present invention is indicated by the appended claims rather than by the description of the above-described embodiments and includes all modifications (changes) within the meanings and the scopes equivalent to the claims.

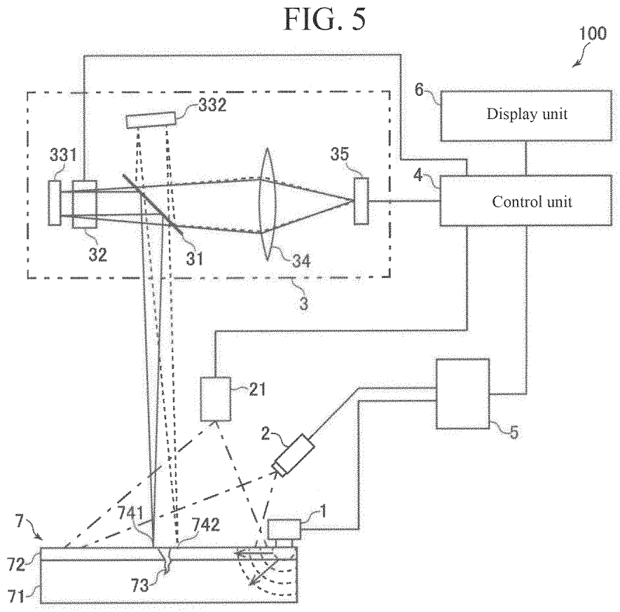

For example, in the above-described embodiment, an example is shown in which it is configured such that a plurality of still images captured to generate a moving image relating to the propagation of vibration of the inspection target are addition averaged to obtain one still image, and the vibration discontinuous portion extracted on the acquired still image is emphasized and displayed. However, the present invention is not limited thereto. In the present invention, as in the modification shown in FIG. 5, it may be provided with an incoherent illumination 21 for irradiating incoherent light to the inspection target 7. Then, the control unit 4 may be configured to perform control of displaying the extracted vibration discontinuous portion so as to be emphasized and superimposed on the still image captured by the image sensor 35 (imaging unit) in a state in which the light is being emitted from the incoherent illumination 21. With this, unlike the case where a still image is imaged by coherent illumination, it is possible to suppress the light from being partially darkened or interference fringes from being reflected in the inspection target 7 due to the shape/structure, dust, etc. Note that incoherent light denotes light with non-uniform amplitude or phase and is therefore light whose interference cannot be observed.

Further, the vibration discontinuous portion extracted on one still image of the plurality of still images captured to generate a moving image relating to the propagation of vibration of the inspection target may be displayed so as to be emphasized and superimposed. Further, separately from a plurality of still images captured to generate a moving image relating to the propagation of vibration of the inspection target, a still image may be captured separately, and the extracted vibration discontinuous portion may be superimposed on the still image captured separately.

Further, in the above-described embodiment, an example is shown in which a signal generator, a vibrator (excitation unit), and a laser illumination unit are connected via a cable (wired) respectively, but the present invention is not limited thereto. In the present invention, the signal generator, the excitation unit, and the laser illumination unit may be wirelessly connected.

In the above-described embodiment, an example is shown in which a speckle shearing interferometer is used as the interference unit, but the present invention is not limited thereto. In the present invention, other optical interferometers may be used as the interference unit.

In the above-described embodiment, an example is shown in which the inspection target is brought into contact with the vibrator (excitation unit), but the present invention is not limited thereto. In the present invention, an excitation unit may be used so as to be spaced apart from the inspection target surface. For example, a strong speaker or the like may be used as the excitation unit.

In the present invention, a window and/or various optical filter may be arranged on the optical path until the reflected light from the inspection target is incident on the imaging unit in order to protect the optical components and improve the S/N ratio of the device.

Further, in the above-described embodiment, for convenience of explanation, the processing operation of the controller according to the present invention is described using a driven type flowchart that performs processing in order along the processing flow, but the present invention is not limited thereto. In the present invention, the processing operation by the control unit may be performed by event-driven processing that executes processing on an event-by-event basis. In this case, the processing of the control unit may be performed in a complete event-driven fashion or in combination of event-driven type processing and flow-driven type processing.

### DESCRIPTION OF SYMBOLS

1: Vibrator (excitation unit)
2: Laser illumination unit
3: Speckle shearing interferometer (interference unit)
4: Control unit
7: Inspection target
21: Incoherent illumination
35: Image sensor (imaging unit)
73: Defect portion
100: Defect inspection apparatus

1. A defect inspection apparatus comprising:
an excitation unit configured to excite acoustic wave vibration in an inspection target;
a laser illumination unit configured to irradiate the inspection target with laser light;
an interference unit configured to cause reflected light of the laser light arriving from mutually different positions of the inspection target excited by the excitation unit to interfere;
an imaging unit configured to image the interfered reflected light; and
a control unit configured to measure, based on the interfered reflected light imaged by the imaging unit, a periodically varying spatial distribution of physical quantities caused by propagation of vibration of the inspection target and extract, based on the spatial distribution of the physical quantities, a vibration discontinuous portion,
wherein the control unit is configured to perform control of displaying the extracted vibration discontinuous portion so as to be emphasized and superimposed on a still image of the inspection target captured by the imaging unit, and
wherein the control unit is configured to perform control of displaying the physical quantities periodically varying at the extracted vibration discontinuous portion as a moving image so as to be emphasized and superimposed on the still image.

2. (canceled)

3. The defect inspection apparatus as recited in claim 1,
wherein the control unit is configured to perform control of displaying the physical quantities by changing a color to be displayed so as to be emphasized and superimposed on the still image, in accordance with a change in the physical properties of the extracted vibration discontinuous portion.

4. The defect inspection apparatus as recited in claim 3,
wherein the control unit is configured to perform control so that there is a timing at which a color tone is eliminated when changing the color to be displayed so as to be superimposed on the still image, in accordance with the change in the physical quantities of the extracted vibration discontinuous portion.

5. The defect inspection apparatus as recited in claim 1,
wherein the control unit is configured to perform control of displaying the extracted vibration discontinuous portion so as to be emphasized and superimposed on one piece of the still image acquired based on a plurality of still images captured by the imaging unit.

6. The defect inspection apparatus as recited in claim 1, further comprising:
an incoherent illumination unit configured to irradiate the inspection target with incoherent light;
wherein the control unit is configured to perform control of displaying the extracted vibration discontinuous portion so as to be emphasized and superimposed on the still image captured by the imaging unit in a state of being irradiated with light from the incoherent illumination.

7. A defect inspection method comprising:
exciting acoustic wave vibration in an inspection target;
irradiating an inspection target with laser light;
causing reflected light of the laser light arriving from mutually different positions of the excited inspection target to interfere;
imaging the interfered reflected light;
measuring spatial distribution of periodically varying physical quantities caused by propagation of vibration of the inspection target, based on the imaged interfered reflected light;
extracting a vibration discontinuous portion based on the spatial distribution of the physical quantities;
displaying the extracted vibration discontinuous portion so as to be emphasized and superimposed on the captured still image of the inspection target; and
displaying the physical quantities that change periodically at the extracted vibration discontinuous portion as a moving image so as to be superimposed on the still image.
